(19) United States
(12) Patent Application Publication
(10) Pub. No.: US 2010/0012728 A1
(43) Pub. Date: Jan. 21, 2010

(54) SYSTEM FOR READING AT LEAST ONE BARCODE

(75) Inventors: Henri Rosset, Le Pin (FR); Thibaut D'Argentre, Paris (FR)

Correspondence Address: OLIFF & BERRIDGE, PLC, P.O. BOX 320850, ALEXANDRIA, VA, 22320-4850, US

(73) Assignees: ARJOWIGGINS, Issy Les Moulineaux (FR); ARJOWIGGINS SECURITY, Issy Les Moulineaux (FR)

(21) Appl. No.: 12/298,259

(22) PCT Filed: Apr. 26, 2007
(86) PCT No.: PCT/FR2007/051182

§ 371 Date: Feb. 5, 2009

(30) Foreign Application Priority Data
Apr. 27, 2006 (FR) 0651497

(51) Int. Cl. G06K 7/10

(52) U.S. Cl. 235/462.05; 235/462.13; 235/468

(57) ABSTRACT

The present invention relates to a method of reading at least two bar codes with the aid of a reading system comprising: first and second illuminants capable of emitting respectively first and second luminous radiations having different spectral characteristics and an optical detector, the system being arranged so as to allow the reading, with the aid of the detector, of a first bar code when illuminated by the first illuminant and of a second bar code when illuminated by the second illuminant, in which method the first and second bar codes are disposed on two different substrates and in which the first bar code is read with the first illuminant and the second bar code with the second illuminant.

The present invention relates in particular to a system for reading at least one barcode.

A label comprising a barcode produced with a mix of inks respectively sensitive to UV and IR radiation is known from the international patent application WO 01/28781. This barcode is invisible to the naked eye in daylight. The reading of the barcode is carried out using a UV reader comprising a diffuse UV illuminant (also called the source). An additional identification operation is carried out using an IR illuminant to reveal the presence of IR ink of the barcode.

A barcode reader comprising an illuminant with a wavelength of 405 nm and a detector sensitive to visible light is known from the U.S. Pat. No. 6,824,061. This reader enables a barcode to be read that is produced with a phosphorescent ink which is invisible to the naked eye in daylight and capable of releasing visible light that can be detected by the detector when the barcode is illuminated by the illuminant.

A banknote comprising a barcode produced with a luminescent ink is also known from the patent application US 2004/0245343.

A barcode invisible to the naked eye in daylight that is printed on a magnetic strip is also known from the U.S. Pat. No. 5,932,870.

A device for reading a security marking comprising a barcode portion visible in natural light and a barcode portion invisible in natural light is known from the U.S. Pat. No. 6,354,501.

A barcode reader device comprising a first illuminant in the visible region and a second illuminant in the infrared is known from the patent application DE 3839772.

The subject of the invention, according to one of its aspects, is a method of reading at least two barcodes using a reader system comprising:
first and second illuminants capable of respectively emitting first and second luminous radiations having different spectral characteristics; and
an optical detector;
   the system being arranged to allow, using the detector, the reading of a first barcode when illuminated by the first illuminant and of a second barcode when illuminated by the second illuminant,
   in which method the first and second barcodes are positioned on two different substrates and in which the first barcode is read with the first illuminant and the second barcode is read with the second illuminant.

The two substrates may be physically independent, being carried for example by two distinct objects.

The first barcode may be readable when the substrate carrying it is illuminated by the first luminous radiation and the second barcode may be readable when the substrate carrying it is illuminated be the second luminous radiation.

The first barcode may be carried by an article and the second barcode may be carried by a means of payment for this article, in particular a banknote, a check, a coupon, a gift voucher, a bank card or a store payment card.

The reading of the two barcodes can be carried out by simultaneously illuminating the two barcodes with the two illuminants.

The first barcode may be undetectable to the naked eye in daylight.

The article may comprise the first barcode and a third barcode, one of the first and third barcodes being capable of being read by the reader system by being illuminated by the first illuminant and the other of the first and third barcodes being capable of being read by the reader system by being illuminated by the second illuminant.

The presence of two barcodes on the article allows different types of information to be encoded.

The first and third barcodes may be at least partly superposed.

One of the first and third barcodes may be visible to the naked eye in daylight and the other of the first and third barcodes may have fluorescence properties under UV or IR light.

It is possible to read the first and third barcodes by illuminating them with a single one of the illuminants.

The subject of the invention, according to another of its aspects, is a reader system for reading at least one barcode, this system comprising:
first and second illuminants capable of respectively emitting first and second luminous radiations having different spectral characteristics; and
an optical detector;
   the system being arranged to allow, using the detector, the reading of a first barcode when illuminated by one of the illuminants and of a second barcode when illuminated by the other illuminant.

The reader system according to the invention enables a single detector to be used to read barcodes having different optical properties, one being visible to the naked eye, for example, and the other invisible to the naked eye.

It is thus possible to avoid the use of two distinct reader systems for reading different barcodes.

Advantageously, at least one of the two illuminants is a UV or IR illuminant, allowing barcodes produced in particular with an ink having UV or IR fluorescence to be read. At least one of the barcodes can thus be invisible to the naked eye in daylight, its reading taking place under a UV or IR illuminant.

The detector is preferably sensitive to at least one of the first and second luminous radiations. For example, at least one of the two illuminants is set up to emit visible radiation, in particular red radiation, and the detector may be sensitive to this visible radiation.

The reader system may be produced so as to enable reading, on the one hand, of barcodes printed with an ink that is visible in daylight and, on the other hand, of barcodes produced with an ink that is fluorescent under UV or IR light, chosen so as to emit radiation by fluorescence in the visible, for example blue or red radiation, detectable by the detector of the reader system.

Blue fluorescence may allow better contrast relative to red visible radiation and hence, where necessary, more reliable reading of the barcode using the optical detector.

In an exemplary implementation of the invention, the system is set up so as to allow simultaneous emission from the two illuminants.

For example, when reading a barcode produced with a UV or IR fluorescent ink, only the illuminant emitting a UV or IR radiation is used to read the barcode, the visible luminous radiation emitted by the other illuminant not affecting the reading of this barcode.

This visible luminous radiation, even if it is not directly used to read the barcode, can nonetheless be used as a luminous indicator to enable the operator to spot the area scanned with the UV or IR radiation with the naked eye, which may facilitate the barcode reading operation. This latter operation is advantageously carried out so as to exhibit sufficient contrast under at least one of the illuminants to enable reliable reading using the detector.

Advantageously, at least one of the illuminants is set up to emit a directional light beam, this beam forming, for example, a relatively narrow light beam. The two illuminants may, where appropriate, emit light with approximately the same divergence and direction of the light beam.

The UV or IR beam directed onto a barcode produced with a UV or IR fluorescent ink in view of its reading may, in an exemplary implementation of the invention, make only a relatively narrow portion of this barcode apparent, which allows the presence of the barcode not to be revealed too obviously. The barcode reading operation may thus more easily go unnoticed by the eyes of a person other than the operator situated nearby.

One of the illuminants emitting visible luminous radiation may advantageously be used to reduce the visibility of the portion of the barcode made apparent by the UV or IR beam.

In an exemplary implementation of the invention, the reader system is set up so as to allow, according to preference or, only one of the first and second illuminants to be switched on.

To this end, the system may comprise two switches, each associated with one of the illuminants.

It is thus possible, independently of barcode reading, to use the reader system to check the authenticity of a document, for example a banknote, comprising security elements such as a fluorescent marker, by illuminating this document with, for example, the UV or IR illuminant of the system.

The term “switch” above should not be understood in a restrictive manner and encompasses diverse electromechanical or electronic components. Where appropriate, the two switches may be brought together within the same component.

The system advantageously comprises a portable reading device, set up in particular to be able to be manipulated by the user with just one hand, the illuminants and the detector being housed within this reading device.

The first and second illuminants may respectively emit light mainly at first and second wavelengths, being approximately monochromatic for example.

The detector may comprise a filter set up to eliminate one of the first and second wavelengths. Such a filter may, particularly in the case of simultaneous emission by the two illuminants, prevent the luminous radiation emitted by at least one of the illuminants from reaching the detector, which may avoid its saturation by this luminous radiation. The filter may, for example, only transmit at the fluorescence wavelength of the barcode.

The subject of the invention, according to another of its aspects, is also an assembly comprising:
a reader system as defined above;
at least one article comprising at least one barcode, for example undetectable to the naked eye in daylight, the barcode being produced, for example, based on at least one ink that is fluorescent under UV or IR light.

In an exemplary implementation of the invention, the article comprises at least two barcodes, one capable of being read by the reader system by being illuminated by the first illuminant, and the other barcode capable of being read by the reader system by being illuminated by the second illuminant.

These two barcodes are, for example, read successively by having the two illuminants emit light successively.

The two barcodes may be at least partly superposed.

In an exemplary implementation of the invention, the barcode is produced by printing onto a substrate of the article, in particular by offset, screen, intaglio, letterpress, gravure or flexographic printing, this list not being limiting.

The article may comprise a substrate, for example a fibrous substrate, bearing at least one security element in strip from, the barcode being produced on this strip element.

The strip element may in particular be a wide security thread, for example having a width between 2 and 10 mm.

This element is preferably at least partly embedded in the bulk of the substrate.

As a variant, the article may comprise a foil present on one side of the substrate and the barcode may be carried by this foil. The latter may have been transferred onto the substrate, for example by applying heat and/or pressure. The foil may extend from two opposite edges of the substrate or, as a variant, take the form of a patch of predetermined size.

In order to enhance the security level and/or improve the adhesion of a foil to the substrate, the latter may receive, for example by screen printing, an adhesion primer that may comprise a fluorescent pigment allowing authentication under a UV illuminant.

A pattern may be created on a strip of primer that is applied to the substrate, optionally using areas that extend on both sides of the primer. A fringe pattern may advantageously be created, the fringes possibly being of different widths and separated by a variable pitch so as to define the barcode.

In another exemplary implementation of the invention, the article comprises at least one strip of iridescent coating, the barcode being produced by at least one of the following: overprinting on the coating strip and formation of a pattern using the coating strip.

The article may be one of the following elements:
a security and/or value document, in particular a means of payment, for example a banknote, a check, a coupon, a gift voucher, or a payment card, an identity document, an admission ticket for an event (sport, show etc.) or a transport ticket;
packaging, for example a packing box.

The article may, as a variant, be a label.

The subject of the invention, according to another of its aspects, is also an article comprising at least two barcodes, one having UV or IR fluorescence properties and the other being visible to the naked eye in daylight.

The subject of the invention, according to another of its aspects, is also a method of reading at least one barcode using a reader system as defined above, the method comprising the step consisting in:
reading the barcode by illuminating it with at least one of the illuminants.

The reading of the barcode may be carried out by illuminating it simultaneously with the two illuminants. As a variant, the reading of the barcode may be carried out by illuminating it with only one of the illuminants.

The method may also comprise the following step:
reading two different barcodes, one of the barcodes being detectable when illuminated by the first luminous radiation and the second barcode when illuminated by the other luminous radiation.

The subject of the invention, according to one of its aspects, is also a method for authenticating an article, especially a banknote, comprising a barcode, the method comprising the following step:
authenticating the barcode of the article using a reader system as defined above, in particular by illuminating the barcode with one of the illuminants of the reader system.

This method can be implemented, for example, at a point of sale, in particular by a salesperson at the checkout of a shop.

The subject of the invention, according to another of its aspects, is also a method for reading the barcode of an object and authenticating a means of payment, in particular a banknote, a check, a coupon, a gift voucher, a bank card, or a store payment card, the method comprising the following steps:
reading the barcode of the object using a reader system as defined above; and
authenticating the means of payment using the same reader system.

The reading of the barcode of the object may be carried out using one of the illuminants of the reader system and the authentication of the object using the other illuminant of the reader system.

The invention will be able to be better understood on reading the following detailed description of nonlimiting exemplary implementations thereof, and on examining the appended drawing, in which:

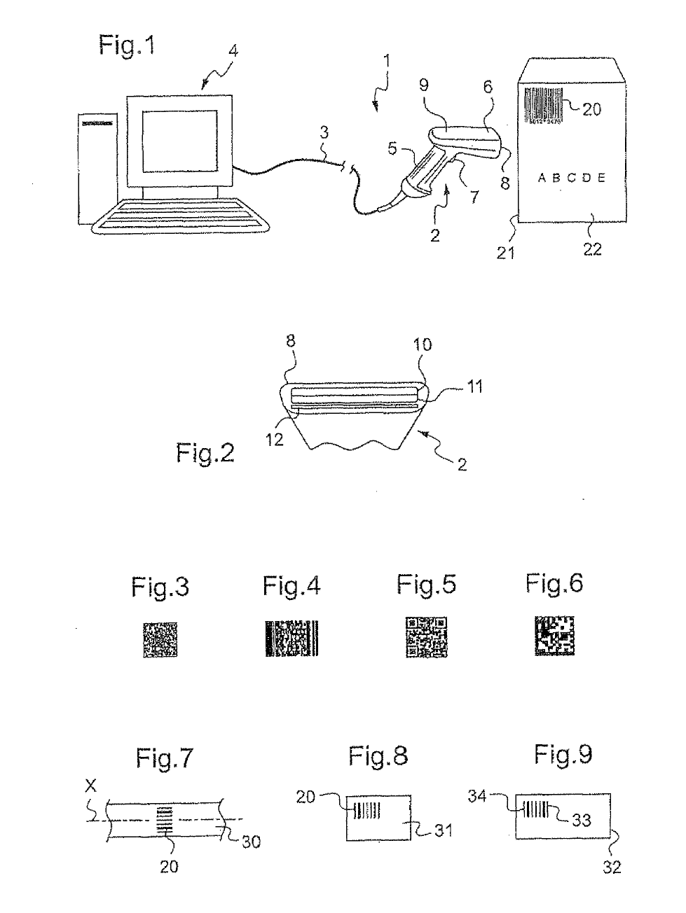

FIG. 1 schematically and partly represents a barcode reader system according to the invention and a document comprising a barcode;

FIG. 2 schematically and partly represents a reading device of the system from FIG. 1;

FIGS. 3 to 6 schematically and partly represent various examples of barcodes;

FIGS. 7 and 8 schematically and partly represent two examples of security elements comprising a barcode; and

FIG. 9 schematically and partly represents an article according to an exemplary implementation of the invention.

FIG. 1 represents a reader system 1 enabling the reading of at least one barcode. This system 1 comprises a reading device 2 connected, for example by a cable connection 3, to a processing unit 4, for example a computer.

The reading device 2 may comprise a handle 5 enabling the user to manipulate this device like a pistol.

In the example illustrated, the reading device 2 comprises a casing 9 defining a head 6 and the handle 5, this head 6 having a reading window 8, as illustrated in FIG. 2.

The reading device 2 comprises, behind the reading window 8, first 10 and second 11 illuminants, set up respectively to emit UV radiation, for example at a wavelength of around 365 nm or 254 nm, and radiation in the visible spectrum, for example red radiation, in particular at a wavelength of around 630 nm.

The UV illuminant may be replaced, where appropriate, with an IR illuminant.

The illuminants 10 and 11 comprise, for example, one or more light emitting diodes (LEDs) or lasers, and may be set up so as to emit directional luminous radiation in the form of a relatively narrow light beam. The latter beam may, for example, form an approximately rectangular light trace on the surface onto which it is projected.

In the example considered, the system 1 is set up to allow the simultaneous operation of the two illuminants 10 and 11.

The reading device 2 may comprise a trigger 7 or any other control system for initiating the reading of a barcode.

The reading device 2 furthermore comprises, behind the reading window 8, an optical detector 12, for example of the linear CCD type, set up to receive light reflected from a barcode illuminated by at least one of the illuminants 10 and 11.

The detector 12 may be set up to read 1D or 2D barcodes.

The detector 12 may be set up to be sensitive to visible luminous radiation emitted by the second illuminant 11 and reflected by the article thus lit, and may comprise, if desired, a filter set up to eliminate, for example by reflection, the radiation emitted by the first illuminant 10.

The reader system 1 enables the reading of a barcode present on the article, in particular a security and/or value document 21, for example a banknote, a check, an identity document, an admission ticket for an event or a transport ticket. As a variant, the article may be a label or packaging, for example a packing box.

The article 21 comprises a substrate 22, made of paper for example, and the barcode 20 can be affixed to this substrate by printing, in particular by offset, screen, intaglio or letterpress printing.

The barcode 20 is, for example, of the type EAN8, EAN13, UPC or ISBN. As a variant, the barcode may be a 2D type barcode, for example of the type PDF 417 (see FIG. 4), DATAMATRIX (see FIG. 6), MAXICODE (see FIG. 3) or QR CODE (see FIG. 5).

In the example considered, the barcode 20 has UV fluorescence properties, being produced for example using an ink that is fluorescent under UV light. This barcode is invisible to the naked eye in daylight.

The fluorescent ink may comprise, for example, organic or mineral pigments. The nature of these pigments and/or their concentration is chosen so that the level of contrast between the light and dark areas of the barcode 20 is sufficient to allow the barcode 20 to be read reliably by the reader system 1.

The barcode 20 may be printed on a security element in a strip 30, as illustrated in FIG. 7.

The strip element 30 is, for example, at least partly embedded in the bulk of the substrate 22.

In the example illustrated in FIG. 8, the barcode 20 is printed on a foil 31 fixed, for example glued, to one side of the substrate 22 of the article 21.

As a variant, the barcode 20 may be printed, as a primer, under the foil 31.

In order to enhance the security level and/or improve the adhesion of a foil on the substrates the latter may receive an adhesion primer comprising a fluorescent pigment allowing authentication under a UV illuminant.

A pattern may be created, for example by screen printing, on a strip of primer that is applied to the substrate, with areas that extend on both sides of the primer. A fringe pattern may advantageously be created, the fringes being in particular of different widths and separated by a variable pitch so as to define the barcode.

When the article 21 comprises a coating, for example a strip of iridescent coating, the barcode 20 may be produced by overprinting on the coating strip.

The barcode 20 may also be produced by incorporating pigments in an iridescent coating strip and by forming a pattern on the coating strip corresponding to a barcode, as described in the patent application WO 2004/106078 for example.

Of course, the UV fluorescence may be replaced by IR fluorescence if desired.

When the article 21 is a banknote, the barcode 20 may contain information relating, for example, to the face value of the banknote and/or associated with other information stored on a separate data medium, this information containing, for example, a number of the banknote, a geographic localization, or the name of a paper manufacturer for example.

The reader system 1 may be used, for example, at a point of sale, for example in a store, in order to check the authenticity of banknotes during a payment.

The barcode 20 may be read using the reading device 2 while being illuminated by the illuminants 10 and 11.

The barcode 20 illuminated by the illuminant 10 emits, by fluorescence, light that can be detected by the detector 12.

The reader system 1 also enables the reading of a barcode produced with a visible ink, for example black ink, in which case the luminous radiation emitted by the illuminant 11 is used to read the barcode 20.

It is thus possible to read barcodes with fluorescence properties and barcodes visible in daylight simultaneously with the same device.

The luminous radiation emitted by the illuminants 10 and 11 is preferably approximately superposed.

The UV or IR beam directed onto a barcode 20 with fluorescence properties, with a view to reading it, may make apparent only a relatively narrow portion of this barcode at most, which allows its presence not to be revealed too conspicuously.

In addition, by simultaneously or virtually simultaneously emitting visible light, the illuminant 11 is able to reduce the visibility of the portion of the barcode 20 made apparent by the UV or IR beam. The barcode reading operation can thus be relatively discreet.

FIG. 9 represents an article 32 comprising two barcodes 33 and 34, one having fluorescence properties and the other being visible to the naked eye in daylight, these codes being superposed with respect to each other.

The reader system 1 is able to read these barcodes 33 and 34 successively, in which case the system may be set up to allow the illuminants 10 and 11 to be switched on successively.

The expression “comprises a” should be understood as being synonymous with “comprises at least one”, unless specified to the contrary.

1.-23. (canceled)

24. A method of reading at least two barcodes using a reader system comprising:
first and second illuminants capable of respectively emitting first and second luminous radiations having different spectral characteristics; and
an optical detector;
the system being arranged to allow, using the detector, the reading of a first barcode when illuminated by the first illuminant and of a second barcode when illuminated by the second illuminant,
wherein the first and second barcodes are positioned on two different substrates and wherein the first barcode is read with the first illuminant and the second barcode is read with the second illuminant.

25. The method as claimed in claim 24, at least one of the two illuminants being a UV or IR illuminant.

26. The method as claimed in claim 24, the detector being sensitive to at least one of the first and second luminous radiations.

27. The method as claimed in claim 24, at least one of the two illuminants being set up to emit visible radiation.

28. The method as claimed in claim 27, the visible radiation being red radiation.

29. The method as claimed in claim 24, the detector being sensitive to visible radiation.

30. The method as claimed in claim 29, the visible radiation being red radiation.

31. The method as claimed in claim 24, wherein the reading of the two barcodes is carried out by simultaneously illuminating the two barcodes with the two illuminants.

32. The method as claimed in claim 24, at least one of the illuminants being set up to emit a directional light beam.

33. The method as claimed in claim 32, both of the illuminants being set up to emit a directional light beam.

34. The method as claimed in claim 24, comprising a portable reading device, the illuminants and the detector being housed within this reading device.

35. The method as claimed in claim 34, the portable reading device being set up to be able to be manipulated by a user with just one hand.

36. The method as claimed in claim 24, the detector comprising a filter set up to eliminate one of the first and second wavelengths.

37. The method as claimed in claim 24, wherein the first barcode is carried by an article.

38. The method as claimed in claim 37, wherein the first barcode is undetectable to the naked eye in daylight.

39. The method as claimed in claim 37, wherein the article comprises the first barcode and a third barcode, one of the first and third barcodes being capable of being read by the reader system by being illuminated by the first illuminant and the other of the first and third barcodes being capable of being read by the reader system by being illuminated by the second illuminant.

40. The method as claimed in claim 39, the first and third barcodes being at least partly superposed.

41. The method as claimed in claim 39, one of the first and third barcodes being visible to the naked eye in daylight and the other of the first and third barcodes having fluorescence properties under UV or IR light.

42. The method as claimed in claim 41, wherein the first and third barcodes are read by illuminating them with a single one of the illuminants.

43. The method as claimed in claim 37, the first barcode being produced by printing onto a substrate of the article.

44. The method as claimed in claim 43, the first bar code being produced by offset, screen, intaglio, letterpress, gravure or flexographic printing onto a substrate of the article.

45. The method as claimed in claim 37, the article comprising a substrate bearing at least one security element in a strip and the first barcode being produced on the strip element.

46. The method as claimed in claim 37, the article comprising a foil, the first barcode being carried by this foil.

47. The method as claimed in claim 37, the article comprising at least one strip of iridescent coating, the first barcode being produced by at least one of the following: overprinting on the coating strip and formation of a pattern using the coating strip.

48. The method as claimed in claim 37, the article being one of the following elements:
a security and/or value document, a check, a coupon, a gift voucher, or a payment card, an identity document, an admission ticket for an event or a transport ticket; or
packaging.

49. The method as claimed in claim 48, the security and/or value document being a means of payment.

50. The method as claimed in claim 37, the article being a label.

51. A method for reading the barcode of an object and authenticating a means of payment, the method comprising the following steps:
reading the barcode of the object using a reader system comprising:
first and second illuminants capable of respectively emitting first and second luminous radiations having different spectral characteristics; and
an optical detector;
the system being arranged to allow, using the detector, the reading of a first barcode when illuminated by one of the illuminants and of a second barcode when illuminated by the other illuminant; and
authenticating the means of payment using the same reader system.

52. The method as claimed in claim 51, the means of payment being a banknote, a check, a coupon, a gift voucher, a bank card, or a store payment card.

53. The method as claimed in claim 52, the reading of the barcode of the object being carried out using one of the illuminants of the reader system and the authentication of the object being carried out using the other illuminant of the reader system.
